(19) United States
(12) Patent Application Publication
(10) Pub. No.: US 2013/0280686 A1
(43) Pub. Date: Oct. 24, 2013

(54) Medical Procedure Training System

(71) Applicants: Martin Hetland, Sandnes (NO); Soren Frank Andersen, Kobenhavn S. (DK); Lars Kirkeskov Sorup, Vallensbaek Strand (DK)

(72) Inventors: Martin Hetland, Sandnes (NO); Soren Frank Andersen, Kobenhavn S. (DK); Lars Kirkeskov Sorup, Vallensbaek Strand (DK)

(21) Appl. No.: 13/466,688

(22) Filed: May 8, 2012

Related U.S. Application Data
(63) Continuation-in-part of application No. 13/451,052, filed on Apr. 19, 2012.

(51) Int. Cl. G09B 23/28

(52) U.S. Cl. 434/262

(57) ABSTRACT

A medical training development system for development of medical training scenarios (15) is disclosed. The medical training development system comprises an event modules database (110) with a plurality of pre-programmed event modules (120), a scenario programming system (140) connected to the event modules database (110) for accessing the event modules (120) and for programming the medical training scenarios (15) and a medical training scenario database (10).

### CROSS-REFERENCE TO RELATED APPLICATIONS

This application is a continuation-in-part of U.S. patent application Ser. No. 13/451,052 entitled “Method and apparatus for developing medical training scenarios” filed by the present inventors on 19 Apr. 2012. The aforementioned patent application is hereby incorporated by reference in its entirety.

### FIELD OF THE INVENTION

The field of the invention relates to a method and apparatus for developing medical training scenarios and a computer program product stored in a non-volatile memory and which, when executed on a general-purpose computer, enables the general-purpose computer to perform the method.

### BACKGROUND OF THE INVENTION

Medical training systems are known in the prior art. One example of a medical training system is a medical simulation system, such as those produced by the Laerdal Medical AS based in Stavanger, Norway. Such medical simulation systems enable the training of students in responding to the medical needs of patients by simulating a medical emergency or other medical procedure. These medical needs include, but are not limited to, casualty assessment, emergency response, birthing, and cardiopulmonary resuscitation (CPR). Cardiopulmonary resuscitation is an emergency procedure that is performed in an effort to manually preserve intact brain function, until further measures can be taken to restore normal blood circulation and breathing to a patient.

The medical simulation systems often use manikins. The manikin is a life-sized anatomical human model used as a teaching aid in medical education for training students, for example doctors, nurses, paramedics, as well as other learners in, for example, emergency care and resuscitation of humans. A number of companies produce manikins. For example, Laerdal have produced manikins in various forms since the 1960s. Generally, manikins are three-dimensional models of all or part of a human being and are intended to be as realistic as possible in order to provide the learners with a realistic situation. The manikin can be used to instruct learners using a so-called “training scenario”. The training scenarios are designed to be realistic simulations of medical emergencies that might occur in real-life. An instructor can institute one or more of the training scenarios and view how the learner responds to the implemented training scenario.

The medical simulation systems used today are intensive in their use of resources. For example, each of the medical simulation systems require different and separate content to match the educational needs of students. This educational content needs to be evaluated as being clinically correct and adapted to run on different medical simulation systems or for use in different contexts. The assessment of the student's performance by an instructor (or an examiner) is often subjective and/or handled by assessment tools that are not well integrated within the medical simulation execution tools. Most tracking and educational records are currently handled manually or are manually imported into learning management systems. This is a burden to administer and can also create potential errors.

More recently e-learning systems have been introduced. For example, the Laerdal company has developed a self-directed, computer-based course for obtaining basic life support certification and is marketed under the trade name HeartCode™ The HeartCode system enables students to obtain certification and includes a local database recording the names of the students who achieve certification.

A number of e-learning systems for medical simulation are known. For example, Laerdal Medical offers a SimStore centre together with the US Company HealthStream, Nashville, Tenn., which is an e-warehouse that supports the distribution and sale of medical simulation content. Further details of the SimStore and related SimCenter product are included in the Laerdal product information bulletin 11-002, dated 18 Apr. 2011. This product information bulletin describes the global launch of the SimCenter product. The medical simulation content in the SimStore is designed to be used with training products and other medical simulation products, such as those produced by the Laerdal Company.

A number of patent applications are known for integrating various e-learning systems. For example, U.S. Pat. No. 6,193,519 (Eggert et al, assigned to Gaumard Scientific) teaches an interactive, computerised education system that includes an interactive program to use with a simulator such as manikin, and virtual instruments for performing simulated patient care activity under the direction of a program. The interactive program displays a selection of modules to assist a user in learning patient care protocols. The modules are selectable by the user for providing different interactive training sessions involving the different patient care protocols. The virtual instruments used with the simulator in performing the patient care activity co-operate with sensors in the manikin but interface with the computer program and thus provide feedback to the program regarding activity of a student, and confirm proper placement and use of the virtual instruments on the simulator.

Similarly, U.S. Patent Application Publication No. US 2005/0186549 (Huang) teaches a method and skills assessment tool for managing a testing session in a clinical skills testing centre that comprises a plurality of assessment stations. The method disclosed includes configuring a plurality of the assessment stations by associating each of the assessment stations with a case type prior to the beginning of the testing session, receiving electronic identification of a student at one of the assessment stations and, in response to receiving the student's identification, automatically assigning the student to one of the assessment stations.

U.S. Patent Application Publication No. 2011/0223573 (Miller et al. assigned to Kb Port) teaches a method and apparatus for multiple medical simulator integration. The apparatus provides multiple medical simulators which simultaneously receive at least one electronic data source input from each medical simulator and puts these electronic data source inputs into a common digital memory buffer in a time-stamped manner for at least a given training event. Each one of the electronic data source inputs forms a data record throughout the event of a simulated parameter of the training simulator or a physical parameter of the training simulator. The common memory buffer allows independent, simultaneous, synchronised, user-controlled playback of the individual input received within the memory buffer in any number of user-defined configurations.

An article “healthcare simulation and its potential areas and future trends”, SES M's magazine 2011/No. 1 (January) pages 1-6 by J. Barris discusses the pressure of controlling costs in the health care services and reports on healthcare simulation as well as identifying the most relevant topics for future research. The article notes that healthcare simulation has a broad application potential for clinical simulation, operational simulation, managerial simulation and educational simulation. One of the issues associated with healthcare simulation is the growing complexity of healthcare processes. This complexity is also reflected in the growing complexity of the simulation tools. For example, it is necessary to create data from many different healthcare simulations and to compare this data. The data needs to be compared across students, institutions (such as hospitals or universities) and private clinics. The data therefore needs to be based in a common format that allows such comparisons to be made.

The increasing complexity of the healthcare protocols means that the simulations have become more complex. There are, however, common elements in the simulations that can be reused and reprogrammed in different simulations. Such common elements can also be compared against other students and against the performance of the same student in a different context.

The term student as used in this disclosure is not intended to exclusively mean an undergraduate or college student who is attending an MD course, a B. Med. course or similar. The term “student” is also intended to apply to health-care professionals, such as an already-qualified nurse, doctor or paramedic who requires basic and refresher training to maintain his or her competence. It will be appreciated that the term “student” is therefore widely understood in the context of this disclosure to mean those people undergo training using medical simulation devices, e-learning or practical experience.

In addition to a traditional medical simulation system, new types of medical training systems and medical monitoring systems have been introduced in order to monitor and evaluate students in real-life situations. For example, U.S. Patent Application Publication No. 2008/0312565 (assigned to the Board of Regents of the University of Texas system, Austin, Tex. and Laerdal Medical, Stavanger, Norway) describes a CPR sensor in the form of a card including a thin and substantially flat flexible substrate having one or more sensor arrays, a power source, an output interface, a processor or analogue circuit incorporated into a credit-card flat flexible substrate. The CPR sensor of the US '565 publication can be easily carried in a wallet or other personal belonging or item of clothing so that the CPR sensor can be located quickly during an emergency. The CPR sensor is placed on or near to the hands of the person administering CPR and is able to provide immediate feedback to the person administering CPR to indicate that he or she is correctly administering CPR. The incorporation of the output interface enables a transfer of the real-life data to a database for further evaluation at a later stage. The storage of the real-life data in the database can be invaluable when reviewing the person's competence in performing CPR and/or for evaluating the performance of the CPR in the event that there is an enquiry or a lawsuit related to the performance of the CPR.

### SUMMARY OF THE INVENTION

There is therefore a need to develop a medical simulation system that integrates medical simulation execution tools with assessment tools and learning management systems and allows comparison of data across multiple medical simulation scenarios.

This disclosure teaches a medical training system with a training device, a medical simulation management module connected to the training device, and at least one medical training module executable on the training device. The medical training module has at least one medical training scenario for training of students, which comprises at least one scenario code and at least one assessment/annotation template. The division of the medical training module into scenario code and assessment/annotation template enables a greater degree of flexibility. Similar or identical assessment/annotation templates can be used in different or modified ones of the medical training modules and also more than one assess/annotation template can be associated with the same scenario code or medical training module. This allows different emphasis to be placed on different items of training.

The medical training system further comprises in one aspect a medical scenario development system having least one of a pre-programmed event module or a pre-programmed medical training scenario with an associated assessment/annotation template. These pre-programmed event modules or pre-programmed medical training scenarios and assessment/annotation templates represent standardized medical procedures for creation of the scenarios and enable re-use of medical scenario code and assessment/annotation templates in different medical scenarios which improves the quality of the code (and thus training) as well as allowing comparison of trained medical procedures.

The medical training system may also include an instructor control device connectable to the medical simulation management module. The instructor control device can control the running of the medical training module. The instructor control device can use the assessment/annotation templates for the entry of student data. This enables standardised data items to be used and then later stored in a student records database.

A method for the training and assessment of students is also disclosed. The method comprises selection of a medical training module, running the medical training module, generating performance assessment parameters relating to performance steps of the medical training module and scoring the performance assessment parameters. The assessment parameters are stored in a storage device.

The generating of the assessment parameters comprises accessing an assessment/annotation template and generating from the assessment/annotation template a scoring module for scoring of a student performance of a medical procedure. The generation of the assessment parameters from an assessment/annotation template enables a plurality of assessment parameters to be generated depending on the skills to be scored.

A computer program stored on a non-volatile storage device is also disclosed which has logic means for running the medical training module and generating assessment parameters relating to performance steps of the medical training module.

### DESCRIPTION OF THE FIGURES

FIG. 1 shows an overview of the medical training system.

FIG. 2 shows a flow diagram of the method for training students in medical matters.

FIG. 3 shows a flow diagram of the method for collating student performance data from a real-life medical procedure.

### DETAILED DESCRIPTION OF THE INVENTION

The invention will now be described based on the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

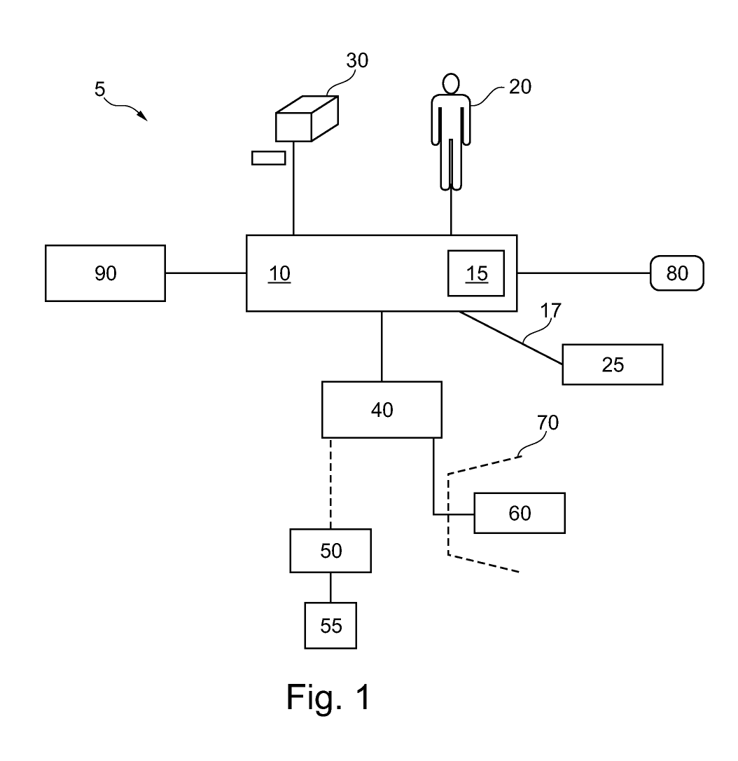

A medical training development system 5 is shown in an architecture view in FIG. 1. The medical training system 5 has a central administrative module 10 that is running on a general-purpose computer, such as a server. It will be appreciated that the central administrative module 10 may be run as a local sever or a remote server or be part of a module running on a cloud server. The central administrative module 10 includes one or more medical training modules 15 that may be stored on the same-general purpose computer or in a separate data store.

The medical training modules 15 include, but are not limited to training scenarios with simulations of medical procedures, such as cardio pulmonary resuscitation (CPR) or other advanced life support cases. It will be appreciated that many such medical training modules 15 are possible and that variations of the medical training modules 15 are possible. For example, one of the medical training modules 15 may include training scenarios relevant to an adult, but a similar medical procedure performed on an infant requires a different or adapted medical training module 15 because of a modified medical training scenario. A data entry device 25 is used by an instructor to enter data and/or control the medical training scenario.

The medical training modules 15 are programmed to run a patient simulator, such as a manikin 20, or a personal computer 30 or in a central administrative module 10 accessed by a remote workstation. The personal computer 30 can be a stand-alone personal computer, a dumb terminal, a tablet computer or a smart phone.

It is known that the different medical training modules 15 running on the central administrative module 10 have a degree of commonality in which similar medical skills are trained. At least some of these common aspects are independent of the type of medical procedure trained by one of the medical training modules 15. These similar medical skills represent examples of “events”. The term “event” is used in this context to indicate various components or stages of the medical procedure or training scenario. The common events may have common data elements associated with them. The common data elements are, for example, parameters indicative of a student's performance in performing one or more of the medical skills across different ones of the medical training modules 15. There are also likely to be “specific” events that are specific to the medical training scenario being performed and have nothing to do with any other one of the medical training scenarios.

A medical simulation generally comprises a plurality of events. The events and the order of the events will change over the course of the medical training scenario represented by the medical training module 15. For example, a first series of events A might occupy the first ten minutes of the medical training scenario undertaken by the student. After running the medical training module 15 for ten minutes, the medical state of a patient might be deemed to change dramatically. This change in the medical state can be done automatically (i.e. is pre-programmed into the medical training scenario) or could be done by an instructor monitoring the student's performance and manually initiating the change. The medical training scenario would then change from the first series of event to a second series of events. The manner in which the instructor uses the data entry device 25 to change the running order of the set of events or introduces new events is outlined below.

An event category is a grouping of events. Each one of the events will be assigned a default category, but the category can generally be changed, or a new category defined. The type of category associated with the event is assigned to the event and stored with the event in metadata. Similarly, a composite event is a small group of individual events that are logically located or grouped to each other. For example, the so-called “six rights of medication” comprise six different events. Each one of the six different events is separately programmed (and can be called up independently). The different events representing each one of the six rights are thus available individually, but are also available as a composite event.

A manikin device 20 is also connected to the central administrative module 10. The connection between the manikin 20 and the central administrative module 10 can be by cable and/or wireless, but this is not limiting of the invention.

The personal computer or other form of display terminal 30 is connected to the central administrative module 10 by cable and/or wireless. A student and/or an instructor can operate the personal computer 30. The personal computer 30 enables access to the medical training modules 15 running on the central administrative module 10 and may enable access to patient records in a patient record database 60, if the student or instructor has sufficient access rights to enable access to this private data. It will, however, be appreciated that laws governing access to such private data are extremely restrictive and thus the medical training modules 15 may write data to such patient record database 60, but rarely allow access to real patient records. The patient records database 60 may be protected by a firewall 70. It may be possible to allow access anonymously or to dummy patient records. In many training system no patient records 60 or only dummy patient records are present.

The personal computer 30 operated by the instructor will enable the instructor to enter data relating to the student's performance and also incorporate a debrief manager. The purpose of the debrief manager is to enable the instructor to discuss the student's performance during the medical simulation. The debrief manager comprises a program module which is run on the personal computer 30 and can access data entered by the instructor during the monitoring of the student as well as videos made of the student. The instructor can enter numerical gradings and or annotations concerning the performance of the student.

A data manager 40 is connected to central administrative module 10 by cable or wireless. The function of the data manager 40 is to extract from the central administrative module 10 any data relevant to the performance of the student in carrying out the medical training scenario. The data is extracted, in one aspect of the system, in a form of a long file. The relevant data may also be extracted in other structured data formats. The data manager 40 can receive data from and pass data to the manikin 20 and/or from the personal computer 30 and/or from an instructor entering data on the data entry device 25. The data manager 40 can receive the data from of pass the data to the patient records database 60 (as disclosed above) and/or receive or write the data into the student records database 50. The data manager 40 is shown as a separate unit in this figure, but can also be incorporated into the central administrative module 10 or be present elsewhere.

The data manager 40 can be part of a learning management system that enables the student to monitor his or her learning goals and outcomes.

The data in the student records database 50 includes the names of the student, e.g. as entered through the personal computer 30, and also any data relating to the types of medical competences for which the student is trained as well as expiry dates of any certification requirements for a particular medical competence. The student records database 50 also includes verifiable keys accessible by, for example, an employer or a regulatory agency to verify any information and certify that the information stored in the student records database 50 is genuine.

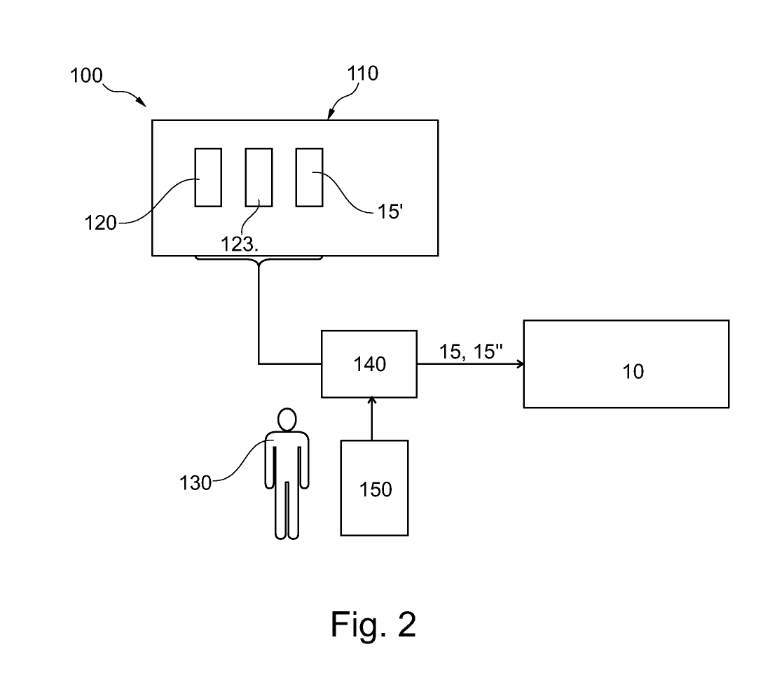

FIG. 2 shows an example of a medical training scenario development system 100. The medical training scenario development system 100 is used to create and/or amend the medical training modules 15 for running on the central administrative module 10, one or more manikin devices 20 and/or one or more of the personal computers 30, as explained above.

The medical training scenario development system 100 comprises a repository 110 and a scenario programming system 140. The scenario programming system 140 is programmed by a scenario programmer 130. The repository 110 comprises a plurality of event modules 120 and may also comprise pre-programmed medical training modules 15′. The medical training scenario system 100 is shown in this figure as a separate unit, but it will be understood that the medical training scenario development system 100 could also be part of the central administrative module 10 or run on the personal computer 30.

The event modules 120 comprise a series of instructions (coding) that can be used to operate the manikin devices 20, the central administrative module 10 and/or the personal computer 30 to implement the events as well as to develop performance assessment templates 123. The event modules 120 will include instructions to extract any required data from the student records database 50 and from the personal computer 30 or manikin devices 20 as well as instructions to write the data into the student records database 50 (or other database). The event modules 120 are pre-programmed and can be used in the development of multiple medical training scenarios.

The medical training scenario development system 100 may also include one or more of the existing (i.e. pre-programmed) medical training modules 15′ and can be used to change, update, or recode the existing ones of the medical training modules 15. In other words a “mother” one of the medical training modules 15′ can be used to generate a “daughter” one of the medical training modules 15″.

In one aspect, the event modules 120 (and the medical training modules 15, 15′ and 15″) are programmed using an XML schema. The XML schema is stored in a non-volatile memory, which forms the repository 110. The non-volatile memory contains a plurality of memory elements for physical storage of data. The XML schema includes the instructions for the operation of the central administrative system, the manikin devices 120 and the personal computers 30, as well as metadata.

The metadata is “data about data” and is, in essence, descriptors which describe, for example, the roles of the students and/or the instructors, the intended outcomes of the medical training scenario, parameters collected about the performance of the student. The metadata can be interpreted by the manikin 20, the data entry device 25, the personal computer 30, the data manager 40, etc., and used partially to identify the events programmed by the event module 120 and also to arrange for the collection of data which is relevant to the performance by the student of the event. The use of the metadata enables the cross-reference of the collected data across one or more of the events.

Examples of the metadata include the following:
ViewItems Key—the unique ID of an event
DisplayName Lang—the language of the event, for translation purposes
ViewItem—an event
Event—a normal event, no extra values
StringEvent—an event that has a text-based value
EnumEvent—an event that has multiple text-based values
IntEvent—event that has an integer value
DoubleEvent—an event that has a numerical value
DrugEvent—an event with values for dose and route
CompositeViewItem—and event with sub-events within it
BoolEvent—An event that has a true/false value
EnumEvent DefaultValue—the default value of an event of type enumevent
AllowMultiple—determines whether or not you can register multiple values for the event or not
Id—the name of the event
Lang—the language of the event
Roles—if the event have a role or many roles associated with it, meaning e.g. Head nurse are expected to carry out this event
Role Lang—name of the role
InstructorProperties—properties that deals with creating a more intelligent workflow during simulation
Critical—shows an icon on events that might lead to drastic consequences in the medical training scenario. A critical event not performed by the student on the patient will lead to failure of medical training scenario being performed.
ShowCounter—whether or not the event should show a counter for every time it is registered
Count—the actual number of times the event has been registered (requires enablement of the ShowCounter
Highlight—the next event anticipated according to the scoring algorithm should be highlighted so that it is easier to find for the instructor
ShowOnceInView—if this is set to true, the event will disappear from the view on an instructor's device once the event has been registered. Handy for events that only happens once
HideWhenTimeInView_Seconds—maybe an event is only relevant for the first 5 minutes, after that the event probably will not occur at all. This is the ability to auto-hide the event after a given time.
EventInfo—this is information about the event, e.g. the definition of what the event actually is.
LogMessage Lang—This is information that goes into the log together with the registration of the event.

UnsetEvent ShowMainEvent—some events have an “anti-event” connected to them, such as intubate vs. extubate
Id—the name of the anti-event
Lang—language for the for translations purposes
AntiRoles—roles for the anti-event
EnumValue—the actual value of the event, which is set to upon registration

The scenario programmer 130 uses the event modules 120 and/or the pre-programmed medical training scenarios stored in the repository 110 to develop his or her own medical training modules 15″. So, for example, the scenario programmer 130 can always use the event modules 120 relating to “washing of hands” in various different medical training scenarios. The metadata associated with the event module 120 “washing of hands” will enable a comparison to be made across many different medical training scenarios to see whether individual ones of the students consistently wash their hands and whether the same student consistently washes his or her hands when performing different ones of the medical training scenarios. This information can be stored in the common data elements as part of the student records database 50. The event modules 120 with their standardised reports embedded in the XML code can be used to send the data to the student record database 50, as noted above.

The use of the event modules 120 also ensures consistency of coding. There will not be slight variations between events that should be otherwise identical. The event modules 120 therefore enable a greater consistency of training, an increased productivity of the development of the medical training modules 15 by the scenario programmer 130 who does not need to consistently reprogram simple tasks and a greater degree of comparison across various ones of the medical training modules 15 and the student's performance.

It will be appreciated that the event modules database 110 comprises not only event modules 120, but can also comprise composite events that have been pre-programmed (such as the afore-mentioned six rights of medication). It will be furthermore appreciated that the scenario programmer 130 can additionally program his or her own additional code 150 in the scenario programming system 140 if no pre-programmed event modules 120 are available. This additional code 150 can be then stored and re-used by another scenario programmer if the additional code 150 is stored in the depository 110 or elsewhere.

The output of the scenario programming system 140 is the medical training module 15 or updated medical training module 15″, which is provided across to the central administrative module 10.

The patient records database 60 is one of the most sensitive databases and is generally protected by an additional isolation 70, such as a firewall, to prevent unauthorised access. The patient records database 60 is generally accessed only when a medical procedure is performed on a real-life patient as opposed to a performance of the medical training scenario on the manikin 20 (or on the personal computer) and the data relating to the performance of the student on the real-life patient is incorporated into the central administrative module 10.

A quality control system 90 is connected to the central administrative module 10 for monitoring the quality of the training. The quality control 90 will generally have access to anonymous data from the central administrative module 10, i.e. without access to the student's names or other identification and/or the patient's names and/or other identifications. The quality control system 90 can also be used to data mine the student record database 50 in order to compare the quality of the training across the students. The use of the metadata in the event modules enables the student record database 50 to be populated with standardised data allowing such comparisons to be made.

It will be appreciated that the manikin 20 shown here does not need to be placed in a central training unit. On the contrary, in order to ensure that students are regularly trained the manikin 20 can be housed in a side room near a ward of a hospital. This will allow the student to undertake regular medical training whenever it becomes convenient for him or her. There is no need for the student to register for a training course in order to obtain recertification.

The advantage of having the manikin 20 near the student's work place is also that the student can be instructed, for example by email, to undertake regular refresh courses in order to maintain his/her competence in the performance of medical procedures. The refresher courses are one example of the medical training modules 15 and different refresher courses can be given at different intervals.

The personal computer 30 will also enable the student to undertake regular and continuous education on various aspects of medical procedure. For example, the guidelines of the American Heart Association on CPR have recently been updated. The central administrative module 10 can inform the student about the update and arrange for the student to take an appropriate one of the medical training modules 50 in order to be updated on the revised medical procedure. The central administrative module 10 can record the student's completion of the training and provide feedback to the student and/or the quality control 90 to enable important action to be taken.

It will be appreciated that the use of the event modules 120 easily allows variations of training to be carried out so, for example, the medical training scenario can be slightly altered between different refresher causes for the individual students to ensure that the students are performing well, even when confronted with new variations on the medical training scenario. The metadata in the event modules 120 allows an easy comparison between the student's performance on the current medical training scenario with the student's past performance.

The manikin 20 and/or the personal computer 30 record the student's performance when performing the medical training module 15 and provide feedback to the central administrative module 10. In particular, this feedback can include whether the student requires further training and/or has meet the requirements to obtain certification. In one further aspect of the invention, an instructor or an invalidator has a data entry device 25 that he or she uses to record the student's performance and to pass details of the performance to the central administrative module for review and recording. The data entry device 25 may also include the debrief viewer.

The data entry device 25 receives instructions and information that have been encoded into the medical training module 15. The use of the XML data means that similar functions can be performed by different ones of the data entry devices 25, if these data entry devices 25 are capable of doing these functions. The data entry device 25 includes the code that interprets the XML data. The data entry device 25 also receives instructions to enable the instructor to change the sequence of the medical training scenario. The data can be entered on the data entry device 25 either by using free-text initiations or by using standardised input values that are generated by the initiation/assessment templates.

It will be appreciated that the functions of the central administrative module 10, the quality control 30 and the data manger 40 overlap to a certain extent. These are generally implemented as computer programs running on a general-purpose computer and the instructions are stored on a non-volatile memory device. It will be further appreciated that the components may be implemented in different manner, depending on the general-purpose computer system on which they are running.

In one further aspect of the invention the data entry device 25 may be a code sheet completed by a nurse or instructor and logged in an appropriate log. This code sheet will include the performance assessment parameters. Any data from the log or code sheet, such as the performance assessment parameters, can be transferred either electronically or by manual entry to the central administrative module 10.

One further example of the data entry device 25 used in this disclosure is the advanced video system developed by Laerdal and described in a press release, dated 30 Mar. 2011. The advanced video system will interpret the XML files supplied with the medical training module 15 and arising from the pre-programmed event module in order to understand which items should be videoed and the manner in which the items should be stored in the student record database 30.

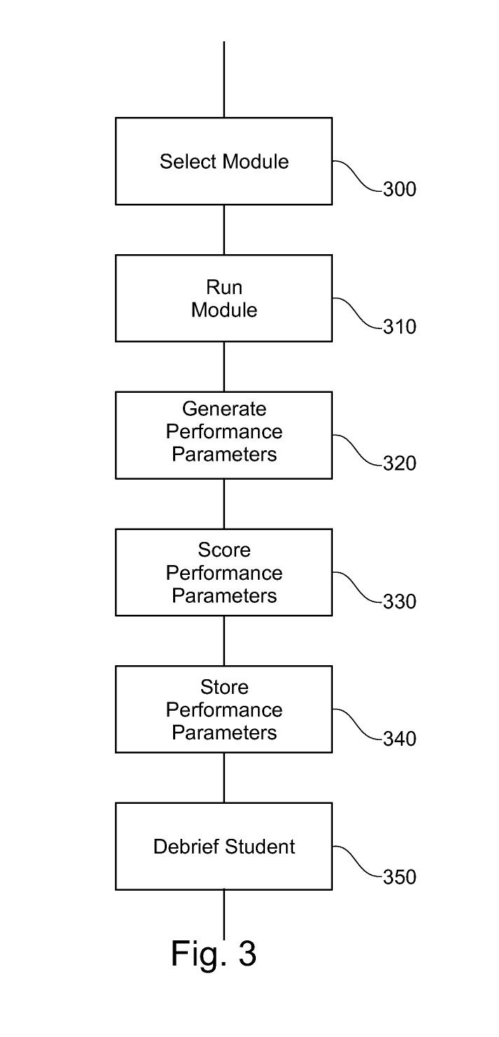

FIG. 3 shows an example of a workflow used in the training and assessment of students that comprises a selection in step 300 of a medical training module 15. The medical training module 15 is run step 310 on the manikin 20 or the personal computer using the medical scenario code.

The performance assessment parameters 17 are generated in step 320 using the assessment/annotation template 123. The performance assessment parameters 17 are generated either in the personal computer 30 or on the data entry device 25. As noted above the performance assessment templates 17 relate to performance steps of the medical training module 15. The instructor can score in step 330 the performance assessment parameters 17 using a standardised grading scheme. The performance assessment parameters 17 are stored in step 340 in a storage device, such as the students record database 50 in a structured manner that enables ready access.

The generating of the assessment parameters 17 comprises accessing the assessment/annotation template in step 320 and generating a scoring module for scoring of a student performance of a medical procedure.

Finally in step 350 the student can be debriefed using the debrief viewer.

It is also possible for an automated grading for the student to be developed based on the results in the scoring module. For example, an assessment of the skills of a student in handling a cardiac arrest could be a weighted average of clinical skills and team skills. The clinical skills and team skills are broken down into smaller events each of which is individually scored or graded. The total grade for the medical procedure is then a weighted grading of all of the smaller events. There are some events noted above which are “critical”. If these critical events are individually failed then the whole of the assessment is failed.

It will be understood that the system and method described herein may be performed using a general-purpose computer that is specifically programmed to perform these tasks. Additionally, the apparatus and methods described herein may be embodied as a combination of hardware and software. The software can be programmed in a variety of computer languages. To simplify the operation and the collection of data, a XML format has been developed for the medical scenario 15. The individual ones of the devices on which the medical scenario is running interpret those XML instructions in an appropriate manner and can ignore those XML instructions, which are not relevant to that device. It will be appreciated that the XML file format is only one example of a suitable file format. Thus, the present invention should not be limited by any of the exemplary embodiments, but should be defined only in accordance with the following claims and their equivalents.

### REFERENCE NUMERALS

5 Medical Training Development System
10 Central Administration Module
15 Medical training modules
17 Performance assessment parameters
20 Manikin
25 Data entry device
30 Personal computer
40 Data Manager
50 Students record database
60 Patient record database
70 Firewall
90 Quality control system
100 Medical Training Development System
110 Repository
120 Event modules
130 Scenario Programmer
140 Scenario programming system
150 Additional code

1. A medical training system comprising:
a training device;
a medical simulation management module connected to the training device;
at least one medical training module executable on the training device and comprising at least one scenario for training of students, wherein the at least one medical training module comprises at least one medical training scenario code and at least one assessment/annotation template.

2. The medical training system of claim 1, further comprising a medical scenario development system having:
at least one of a pre-programmed event module or a pre-programmed medical training scenario; and
an associated assessment/annotation template.

3. The medical training system of claim 1, further comprising:
an instructor control device connectable to the medical simulation management module and adapted to use at least one of the assessment/annotation templates for the entry of student data.

4. The medical training system of claim 1, further comprising:
a student records database connectable to the medical simulation management module.

5. A method for the training and assessment of students comprising:
selection of a medical training module;
running the medical training module;
generating performance assessment parameters relating to performance steps of the medical training module;
scoring the performance assessment parameters; and
storing the scored assessment parameters in a storage device.

6. The method of claim 5, wherein the generating of the assessment parameters comprises accessing an assessment/annotation template and generating a scoring module for scoring of a student performance of a medical procedure.

7. The method of claim 5 wherein the storing of the assessment parameters is in at least one of a student record database or an instructor device.

8. The method of claim 5 further comprising debriefing a student.

9. A computer program stored on a non-volatile storage device and comprising:
logic means for the selection of a medical training module;
logic means for running the medical training module;
logic means for generating assessment parameters relating to performance steps of the medical training module; and
logic means for storing the assessment parameters in a storage device.
